(19) United States
(12) Patent Application Publication
(10) Pub. No.: US 2025/0296844 A1
(43) Pub. Date: Sep. 25, 2025

(54) METHODS AND SYSTEMS FOR PRODUCING AMMONIA AND FOR LONG-TERM DEPOSITING OF CARBON DIOXIDE

(71) Applicant: HORISONT ENERGI AS, Sandnes (NO)

(72) Inventor: Nikola FELBAB, Sandnes (NO)

(21) Appl. No.: 18/863,009

(22) PCT Filed: May 5, 2023
(86) PCT No.: PCT/EP2023/062054

§ 371 Date: Nov. 5, 2024

(30) Foreign Application Priority Data
May 6, 2022 (EP) 22172174.9

(51) Int. Cl. C01C 1/04; C01C 1/02

(52) U.S. Cl. CPC C01C 1/04; C01C 1/024

(57) ABSTRACT

Methods and systems for producing ammonia and for long-term depositing of carbon dioxide are disclosed, wherein off-site produced cold carbon dioxide received at the plant from a road vehicle, railway car, or vessel is used for cooling locally produced ammonia from a local ammonia production plant, such as a blue ammonia production plant.

### FIELD OF THE INVENTION

The present invention relates to a method and system for producing ammonia and for long-term depositing of carbon dioxide, wherein off-site produced cold carbon dioxide is used for cooling locally produced ammonia from a local ammonia production plant, such as a blue ammonia production plant.

### BACKGROUND ART

Capture and disposal of carbon dioxide from processes generating carbon dioxide are known in the art. For example, it is known in the art to dispose pressurized carbon dioxide in underground deposits, e.g. located under the seabed, such as in abandoned oil wells.

Carbon dioxide is generated in various industrial processes, such as fermentation of hydrocarbon containing substrates, combustion of carbonaceous materials, reforming reactions etc. As an example, production of ammonia is often associated with generation of carbon dioxide, such as in instances where the production of ammonia involves reformation or combustion processes.

Production of ammonia is generally an energy consuming process, such as when the ammonia being produced is synthesized from hydrogen and nitrogen. Also, the production of ammonia typically involves cooling of the newly synthesized ammonia in order to liquefy the ammonia.

It would be desirable to be able to reduce the energy required for ammonia production, especially in an ammonia production plant wherein carbon dioxide generated as a by-product from the ammonia production is captured and injected into a long-term deposit. Such ammonia production plant is also referred to herein as a blue ammonia production plant.

The present inventor has found that the above object can be accomplished by using cold off-site produced carbon dioxide for cooling the ammonia being produced.

### SUMMARY OF THE INVENTION

Accordingly, in one aspect the invention relates to a method of producing ammonia at an ammonia production plant also producing carbon dioxide as a by-product, comprising the following steps: A generation of CO₂ in the plant; B generation of NH₃ in the plant; C separating the CO₂ generated in step A; D injecting the separated CO₂ obtained in step C into an underground storage, F cooling the NH₃ produced in step B having a first temperature T₁ to a second lower temperature T₂, which method additionally comprises the following step: E importing to the plant from a road vehicle, railway car, or vessel off-site produced CO₂ having a temperature T lower than the second lower temperature T₂ carried by the road vehicle, railway car, or vessel, and, wherein, in step F at least part of the cooling is carried out using the imported off-site produced CO₂ from step E.

It is preferred that the cooling in step F is carried out mainly, and more preferably solely using the imported off-site produced CO₂ from step E.

The temperature of the cold off-site produced CO₂ will thereby increase. In a preferred embodiment the increased temperature of the heated off-site produced CO₂ is suitable for injection thereof into an underground storage. In a preferred embodiment, the method includes a step H, wherein heated off-site produced CO₂ is injected into an underground storage. Accordingly, such embodiment of the inventive method represents a method for long-term depositing of carbon dioxide. In addition to long-term storage of on-site produced CO₂, said embodiment of the inventive method provides for long-term depositing of off-site produced carbon dioxide, and, also, reducing the energy demand for cooling of the ammonia being produced.

In yet a preferred embodiment the method additionally comprises a step G, in which step separated CO₂ obtained from step C is cooled using off-site produced imported CO₂ obtained from step E.

In another aspect the invention relates to a system for ammonia production and long-term CO₂ storage comprising: a CO₂ and NH₃ producing plant; means for separating CO₂ produced in the plant; means for cooling the NH₃ produced in the plant; piping means for conveying the separated CO₂ to a long-term deposit; wherein the system is configured to receive from a road vehicle, railway car, or vessel off-site produced carbon dioxide carried by the road vehicle, railway car, or vessel, and the means for cooling the NH₃ comprises a heat exchanger having an inlet for the off-site produced carbon dioxide as a cooling medium.

In one embodiment the system for ammonia production and long-term CO₂ storage additionally comprises piping means for conveying heated off-site produced CO₂ exiting the heat exchanger to an underground storage. In addition to long-term storage of on-site produced CO₂, said embodiment of the inventive system accordingly provides for long-term depositing of off-site produced carbon dioxide, and, also, ammonia production with a reduced energy demand for cooling of the ammonia being produced.

In yet another embodiment the system for ammonia production and long-term CO₂ storage additionally comprises a heat exchanger for cooling CO₂ separated in the plant, using CO₂ as cooling medium. Thereby, any additional remaining cooling capacity of the on-site stock of available imported off-site produced CO₂ can be used also for cooling the separated on-site produced CO₂, and thereby further reducing the energy demand in the plant.

In yet two aspects the vicinity of an underground storage and an ammonia plant is taken advantage of so as to provide for a method of producing ammonia wherein the energy requirement for cooling of ammonia is reduced and by means of heating of off-site produced CO₂ for long-term storage thereof in an underground storage located nearby the ammonia plant. Accordingly, in one of said yet two aspects, a method of producing ammonia at an ammonia production plant is provided comprising the following steps: B generation of NH₃ in the plant; F cooling the NH₃ produced in step B having a first temperature (T₁) to a second lower temperature (T₂); which method additionally comprises the following two steps: E importing to the plant from a road vehicle, railway car, or vessel off-site produced CO₂ having a temperature (T) lower than the first temperature (T₁) carried by the road vehicle, railway car, or vessel, and, H injecting the heated off-site produced imported CO₂ resulting from step F into an underground storage, and wherein, in step F, at least part of the cooling is carried out using the imported off-site produced CO₂ from step E.

It is preferred that the cooling in step F is carried out mainly, and more preferably solely using the imported off-site produced CO₂ from step E.

In the other of said yet two aspects, a system for producing ammonia and depositing carbon dioxide is provided comprising: a NH₃ producing plant; means for cooling the NH₃ produced in the plant; wherein the system is configured to receive from a road vehicle, railway car, or vessel off-site produced carbon dioxide carried by the road vehicle, railway car, or vessel, and the means for cooling the NH₃ comprises a heat exchanger having an inlet for the off-site produced carbon dioxide as a cooling medium, and an outlet from said heat exchanger is connected to an underground storage.

Further embodiments and advantages of the invention will be apparent from the following detailed description and appended claims.

The term “blue ammonia” is used herein to generally denote ammonia produced by a method generating, as a by-product, carbon dioxide, wherein the carbon dioxide generated has been captured and stored. The term as used herein is intended to also cover any more restrictive meanings of the term as used in the art, such as e.g. instances wherein the carbon dioxide emanates from methane reformation.

The term “off-site” is used herein to denote a location far removed, typically by at least 100 km, from the location of the ammonia production plant, which far removed location is not connected to the ammonia production plant by a pipeline configured to convey carbon dioxide from the far removed location to the ammonia production plant. The term “off-site” consequently implies that carbon dioxide is not transported by pipeline from the far removed location to the ammonia production plant. The term “off-site” also implies a location where carbon dioxide is liquefied for intermittent long-distance transport, such as to the location of the inventive ammonia production plant.

The term “cold” as used herein, is intended to refer to a temperature below −10° C., preferably −34° C. or lower, and more preferably −47° C. or lower, which is the temperature T of the CO₂ as received at the plant from a road vehicle, railway car, or vessel.

The term “on-site” is used herein to denote the general location where the ammonia production is being carried out, i.e. the location of the ammonia production plant.

The term “import”, as used herein, is intended to refer to the process of forwarding to the ammonia production plant and receiving at the ammonia production plant carbon dioxide produced at a location far removed from the location of the ammonia production plant, i.e. the process of forwarding to the plant and receiving at the plant off-site produced carbon dioxide which has been liquefied for intermittent long-distance transport. Said process of forwarding to the plant off-site produced carbon dioxide includes transport of carbon dioxide by a road vehicle, a railway car, a vessel or a combination of any two or all three thereof.

The term “long-term storage”, as used herein, is intended to refer to a storage for carbon dioxide intended to be permanent, such as an underground storage, preferably located under the seabed.

### DETAILED DESCRIPTION OF THE INVENTION

Captured carbon dioxide is typically pressurized and cooled before being transported, such as by ship, to a location of long-term underground storage. Such long-term underground storage may be located under the seabed. The temperature of carbon dioxide being transported to a destination for long-term storage is typically −47° C. or lower. Before being injected into a long-term underground storage, the cold carbon dioxide typically needs to be heated to higher temperature. The required heating is dependent i.a. on the specific construction and arrangement of the pipeline system leading to the underground storage. Typically, the cold carbon dioxide will preferably be heated to at least −10° C. in order to be able to allow for the use of economical pipeline materials and minimise seawater freezing when being injected into the long-term storage. The present invention is based on using such cold carbon dioxide obtained from another site for cooling purposes on an ammonia production site, especially for cooling purposes beyond ambient cooling, i.e. to a temperature below ambient, of the ammonia produced.

The ammonia production plant is connected to a long-term underground storage for carbon dioxide, into which storage by-product carbon dioxide generated at the ammonia production plant is injected.

For use as feedstock in the ammonia synthesis, it is necessary to generate hydrogen and nitrogen. The ammonia production plant envisaged by the invention therefore typically includes also a system configured to produce hydrogen, and also a system configured to produce nitrogen. The hydrogen is typically obtained at least partly from a carbonaceous feedstock (such as natural gas), in which case CO₂ is produced in the plant, or alternatively only from the electrolysis of water, in which case no CO₂ is produced. The nitrogen is typically obtained from the separation of air.

In the inventive method, the off-site produced CO₂ is preferably heated to a temperature suitable for injection thereof into an underground storage via a pipeline, such as about −10° C. Accordingly, the claimed method allows for receiving at the ammonia production plant off-site produced CO₂ and injecting same into a long-term storage. The long-term storage is preferably the same long-term storage as used for the on-site produced CO₂. The heated off-site produced CO₂ and the cooled on-site produced CO₂ may preferably be co-injected into the long-term storage.

The ammonia is preferably cooled to a temperature T₂ at which the ammonia is in a liquid state at the prevailing pressure, i.e. below the dew point at the prevailing pressure, such as −5° C. at 180 barg.

For an efficient cooling to be obtained according to the invention (in step F), the temperature of the resulting heated CO₂ (from step F) should preferably be at least 5° C. lower than the temperature T₂ of the resulting cooled NH₃.

In the inventive method, the on-site produced CO₂ is preferably at least partly cooled using the cold imported off-site produced CO₂. In a more preferred embodiment the on-site produced CO₂ is cooled using the cold imported off-site produced CO₂.

The inventive system for long-term CO₂ storage comprises an ammonia production plant, which plant also generates, as a by-product, CO₂. The ammonia production plant is typically located by the sea, i.e. by coast or near the coastline or seashore. It is also conceivable that the ammonia production plant is located off-shore. In an embodiment of the system configured for direct cooling of NH₃, the ammonia production plant includes a heat exchanger for cooling the NH₃ produced in the plant, which heat exchanger has an inlet for CO₂ as cooling medium into which inlet imported cold CO₂ is fed. In the heat exchanger, NH₃ having a first temperature T₁ entering the heat exchanger is cooled to a second lower temperature T₂. For a more effective transfer of heat from the ammonia to the cold carbon dioxide, it is preferred that the newly synthesized ammonia is under a high pressure when being cooled by the carbon dioxide. Accordingly, the newly synthesized ammonia, preferably after ambient cooling, may for example be fed to the heat exchanger at a pressure of about 180 barg and a temperature T₁ of about 5° C. Accordingly, in one embodiment T₁ is about 5° C. Similar conditions are preferably also used in embodiments configured for indirect cooling of NH₃, wherein the NH₃ and CO₂, respectively, are fed into different heat exchangers thermally connected by a working fluid loop, as will be described below.

Preferably the system additionally comprises piping means for conveying imported heated CO₂, exiting the heat exchanger, to an underground storage, preferably to same underground storage as the on-site produced CO₂ is conveyed to.

In a preferred embodiment the system additionally comprises a heat exchanger for cooling CO₂ separated in the plant, which heat exchanger has an inlet to receive CO₂ as cooling medium into which inlet imported cold CO₂ is fed. In the heat exchanger, on-site produced CO₂ entering the heat exchanger is cooled.

The piping means for conveying CO₂ preferably connects the plant with the underground storage. For example, a first end of the piping means may be connected to a long-term deposit, which is preferably located underground, and more preferably under the seabed outside the ammonia production plant, and a second end of the piping means may be configured to receive heated off-site produced CO₂ exiting the NH₃/CO₂ heat exchanger, and preferably also heated off-site produced CO₂ exiting the CO₂/CO₂ heat exchanger.

The inventive system is configured to receive off-site produced carbon dioxide. To this end the system may be configured to be connected to a container, e.g. a canister, containing off-site produced CO₂, which container has been transported to the system. The means of transport is not critical, and could e.g. be by road, railway, air, or sea, depending of the local geography and location of the ammonia production plant and infrastructure. Transport by sea is generally preferred. The system could include an intermediate storage tank for holding cold off-site produced CO₂ received at the system from a means of transport. From said tank cold CO₂ could be conveyed via a conduit to the NH₃/CO₂ heat exchanger, and, optionally, also to the CO₂/CO₂ heat exchanger.

While described hereinabove with reference to an ammonia production plant generating carbon dioxide as a by-product, the inventive cooling using off-site produced carbon dioxide could also be used in an ammonia production plant not generating carbon dioxide as a by-product. Such embodiments of the invention principally take advantage of the cooling requirement during ammonia production, and the heating requirement for cold carbon dioxide to be able to be injected into a long-term storage, which storage is located nearby the ammonia production plant. Such embodiments of the invention also principally take advantage of locating an ammonia production plant nearby an underground storage.

In an alternative embodiment, the ammonia production plant does not produce carbon dioxide as a by-product, and is located nearby a long-term underground storage for carbon dioxide, into which storage off-site produced carbon dioxide is injected.

In the inventive methods and systems, part of the imported off-site produced cold carbon dioxide could also be used for transferring gaseous ammonia into liquid ammonia, which phase transition would not necessarily involve a change of temperature of the ammonia, especially in a case where the ammonia is very pure. Such phase transition could for example be provided for after a compressor further downstream in the process.

Accordingly, the inventive methods could include an additional step J, wherein gaseous ammonia is transferred into liquid ammonia using the imported off-site produced CO₂ from step E by heat transfer from the ammonia to the imported off-site produced CO₂.

Analogously, the inventive systems could include an additional heat exchanger or a condenser having an inlet for gaseous ammonia and an outlet for liquid ammonia, and having an inlet for the off-site produced carbon dioxide as a cooling medium, and an outlet for carbon dioxide from said heat exchanger connected to an underground storage.

For thermodynamical reasons it is preferred to use cold imported off-site produced CO₂ to provide cooling (refrigeration) to the NH₃ directly in a heat exchanger. However, in case of a leak or rupture in said heat exchanger, either the CO₂ or the NH₃ may become contaminated with the other, depending on which side of the heat exchanger is at higher pressure. Typically, this would mean the CO₂ being contaminated with NH₃; this carries the potential for formation of solids, such as ammonium carbamate. Formation of solids would present a maintenance challenge and would be disruptive to operations. To avoid this potential problem, it is also possible to use the CO₂ to still provide the cooling duty to the NH₃, but indirectly, via an intermediate working fluid loop, e.g. a water-ethylene glycol mixture. Such a loop would preferably be operated at a lower pressure than either the CO₂ or the NH₃, such that a heat exchanger leak could not contaminate either the CO₂ or the NH₃.

Accordingly, in one embodiment of the respective inventive methods, the cooling in step F is direct, such as using a heat exchanger, where the hot side is NH₃ and the cold side is CO₂. In another embodiment of the respective inventive methods, the cooling in step F is indirect, such as via an intermediate working fluid loop and two heat exchangers, (i.e. one for imported off-site produced CO₂ and one for NH₃, respectively) wherein the working fluid loop thermally connects the two heat exchangers.

Analogously, in one embodiment of the respective inventive systems, the means for cooling the NH₃ is a heat exchanger having an inlet for the off-site produced carbon dioxide as a cooling medium. In another embodiment of the respective inventive systems, the means for cooling the NH₃ comprises the heat exchanger having an inlet for the off-site produced carbon dioxide as a cooling medium, and, additionally, an intermediate working fluid loop, and an additional heat exchanger having an inlet for NH₃ to be cooled in the additional heat exchanger, wherein the intermediate working fluid loop is configured to thermally connect said two heat exchangers.

1. A method of producing ammonia at an ammonia production plant generating CO₂ as a by-product, comprising the following steps:
A generation of CO₂ in the plant;
B generation of NH₃ in the plant;
C separating the CO₂ generated in step A;
D injecting the separated CO₂ obtained in step C into an underground storage;
F cooling the NH₃ produced in step B having a first temperature (T₁) to a second lower temperature (T₂);
additionally comprising the following step:
E importing to the plant from a road vehicle, railway car, or vessel off-site produced CO₂ having a temperature (T) lower than the second lower temperature (T₂) carried by the road vehicle, railway car, or vessel, and,
wherein, in step F, at least part of the cooling is carried out using the imported off-site produced CO₂ from step E.

2. The method of claim 1, additionally comprising a step H, wherein the heated off-site produced imported CO₂ resulting from step F is injected into an underground storage.

3. The method of claim 2, wherein, in steps D and H, the heated imported CO₂ obtained from step F, and the CO₂ obtained in step C, respectively, are co-injected into one and the same underground storage.

4. The method of claim 1, additionally comprising a step G, in which step separated CO₂ obtained from step C is cooled using off-site produced imported CO₂ obtained from step E.

5. The method of claim 1, wherein the underground storage is located under the seabed.

6. A system for producing ammonia and depositing carbon dioxide generated as a by-product during the ammonia production comprising:
a NH₃ producing plant generating carbon dioxide as a by-product;
means for separating CO₂ generated in the plant;
means for cooling the NH₃ produced in the plant;
piping means for conveying the separated CO₂ to an underground storage;
wherein the system is configured to receive from a road vehicle, railway car, or vessel off-site produced carbon dioxide carried by the road vehicle, railway car, or vessel, and wherein the means for cooling the NH₃ comprises a heat exchanger having an inlet for the off-site produced carbon dioxide as a cooling medium.

7. The system of claim 6, additionally comprising piping means for conveying heated CO₂ exiting the heat exchanger to an underground storage.

8. The system of claim 7, wherein the piping means for conveying the heated CO₂, and the piping means for conveying the separated CO₂ lead to, and, are connected to, one and the underground storage.

9. The system of claim 6, additionally comprising a heat exchanger for cooling CO₂ separated in the plant having an inlet for the off-site produced carbon dioxide as a cooling medium.

10. A method of producing ammonia at an ammonia production plant, comprising the following steps:
B generation of NH₃ in the plant;
F cooling the NH₃ produced in step B having a first temperature (T₁) to a second lower temperature (T₂);
additionally comprising the following two steps:
E importing to the plant from a road vehicle, railway car, or vessel off-site produced CO₂ having a temperature (T) lower than the second lower temperature (T₂) carried by the road vehicle, railway car, or vessel, and,
H injecting the heated off-site produced imported CO₂ resulting from step F into an underground storage, and
wherein, in step F, at least part of the cooling is carried out using the imported off-site produced CO₂ from step E.

11. A system for producing ammonia and depositing carbon dioxide comprising:
an NH₃ producing plant;
means for cooling the NH₃ produced in the plant;
wherein the system is configured to receive from a road vehicle, railway car, or vessel off-site produced carbon dioxide carried by the road vehicle, railway car, or vessel, and wherein the means for cooling the NH₃ comprises a heat exchanger having an inlet for the off-site produced carbon dioxide as a cooling medium, and wherein an outlet from said heat exchanger is connected to an underground storage.

12. The system of claim 11, wherein the means for cooling the NH₃ is the heat exchanger having an inlet for the off-site produced carbon dioxide as a cooling medium, which heat exchanger also has an inlet for NH₃ to be cooled therein.

13. The system of claim 11, wherein the means for cooling the NH₃ additionally comprises an additional heat exchanger having an inlet for NH₃ to be cooled in the additional heat exchanger, and an intermediate working fluid loop, wherein the intermediate working fluid loop is configured to thermally connect said two heat exchangers.
